(19) United States
(12) Patent Application Publication
(10) Pub. No.: US 2005/0076302 A1
(43) Pub. Date: Apr. 7, 2005

(54) Display apparatus

(75) Inventor: Hideaki Okamoto, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/954,566

(22) Filed: Sep. 30, 2004

(30) Foreign Application Priority Data
Oct. 3, 2003 (JP) 2003-345824

(51) Int. Cl. G06F 3/00

(52) U.S. Cl. 715/709; 715/705; 715/808; 715/809; 715/711; 715/714; 715/715; 715/970

(57) ABSTRACT

A display apparatus attachable to and removable from a plurality of processing apparatuses used for various purposes, includes a display unit for displaying information, an input unit for inputting information, an input detector for detecting an input at the input unit, a connecting unit connectable with the plurality of processing apparatuses disposed on the exterior of the display apparatus, and a controller for displaying information on how to operate one of the processing apparatuses connected via the connecting unit and for transmitting the information detected by the input detector connected to one of the processing apparatuses via the connecting unit.

This application claims priority from Japanese Patent Application No. 2003-345824 filed Oct. 3, 2003, which is hereby incorporated by reference herein.

### BACKGROUND OF THE INVENTION

1. Field of the Invention

The present invention relates to a guide and help function for facilitating the operation of a product and a display apparatus that can be used commonly for a plurality of products.

2. Description of the Related Art

An instruction manual printed on paper is provided with a product. A user refers to this instruction manual when installing the product or when the user needs instructions for how to use the product. For a product that includes a display, help information can be displayed by inputting a keyword.

However, as the number of functions provided for the product increases, the thicker the instruction manual becomes. Therefore, a user is forced to operate the product with one hand while holding the thick instruction manual in the other hand, and, at the same time, read through the instruction manual. In this way, using an instruction manual is a burden to a user.

For some products, the instruction manual is composed of a plurality of volumes. In such a case, a user might have to spend a significant amount of time searching through the volumes to find the relevant information.

Every newly acquired product, such as a digital camera, a printer, and a video cassette recorder (VCR), comes with an instruction manual. Therefore, the total number of instruction manuals a user possesses increases. These instruction manuals take up a significant amount of storage area. Because of the large number of instruction manuals, some instruction manuals are easily lost, and, thus, it becomes difficult for a user to find the manuals when needed. As a result, a user will not be able to fully use the functions of a product.

Some products that include a display are capable of displaying help information. However, when the display is small, the help information is displayed in small text, being difficult for people, such as elderly persons, having farsightedness to read. Moreover, when a large area of the display is used for displaying help information, there will not be enough space for displaying the information originally displayed on the display.

A method for solving the problem concerning storage of paper instruction manuals is disclosed, for example, in Japanese Patent Laid-Open No. 2002-91647, wherein data of instruction manuals of a plurality of products are stored in a data management system connected to a plurality of household products.

In such a system, however, the original data of the instruction manuals is stored on a CD-ROM. This data, then, has to be transferred to the storage unit of the system. This procedure is not easy for someone who is not used to handling data, such as an elderly person. Furthermore, the system is designed to use a television set as a display apparatus. Therefore, while the television set is used for the system, the television set cannot be used for displaying television programs. Moreover, unless the television set is located near the product to be operated, the product cannot be operated while reading the instruction manual displayed on the television set.

A system for searching and accessing digitalized instruction manuals for products made by various manufacturers stored on a registered database is disclosed in Japanese Patent Laid-Open No. 2001-331499. To read an instruction manual by using such a system, the system must be connected to a network. By connecting the system to a network, a connection fee might by necessary. If the network speed is slow, accessing the instruction manual might be stressful. Information on a personal computer and its peripheral devices can be obtained by connecting a personal computer to a network. However, in order to do so, the user has to have a personal computer available. Even if the user has a personal computer available, the instruction manual cannot be accessed instantaneously. Once the data of the instruction manual is downloaded via the network onto the personal computer, the user can access the instruction manual on the personal computer without connecting to the network. However, to store a plurality of instruction manuals for various products, a memory having an enormous capacity is required. Furthermore, if the personal computer is not located near the product to be operated, a user cannot operate the product while reading the instruction manual. Moreover, there is a problem in that many elderly persons are not familiar with the operation of such a terminal (personal computer). Storing instruction manuals digitally is advantageous for the manufacturers in that costs can be reduced but is not necessarily advantageous for users.

To use a help function based on a keyword search for a personal computer, a user searches for information related to a product stored on a memory by inputting a word or a phrase. However, the word or phrase selected by the user may not be included in the information. From this point of view, the search method still needs to be improved.

A help function does not include a so-called preview function in which the result of an operation can be confirmed before actually carrying out the operation. Therefore, when using a help function, a user cannot confirm whether he will be able to obtain the desired results.

### SUMMARY OF THE INVENTION

It is an object of the present invention to provide a display apparatus that allows a user to easily confirm how to operate a processing apparatus.

To achieve this object, a display apparatus according to an embodiment of the present invention is provided wherein the display apparatus, which is attachable and removable from a plurality of processing apparatuses used for various purposes, comprises a display unit for displaying information, an input unit for inputting information, an input detector for detecting an input at the input unit, a connecting unit connectable with the plurality of processing apparatuses disposed on the exterior of the display apparatus, and a controller for displaying information on how to operate one of the processing apparatuses connected via the connecting unit and for transmitting the information detected by the input detector connected to one of the processing apparatuses via the connecting unit.

To achieve the above-mentioned object, an information system according to another embodiment of the present invention is provided wherein the information system comprises a display apparatus attachable and removable from a plurality of processing apparatuses used for various purposes, the display apparatus comprising a display unit for displaying information, an input unit for inputting information, an input detector for detecting an input at the input unit, a first connecting unit connectable with the plurality of processing apparatuses disposed on the exterior of the display apparatus, and a first controller for displaying information on how to operate one of the processing apparatuses connected via the connecting unit and for transmitting the information detected by the input detector connected to one of the processing apparatuses via the connecting unit. One of the processing apparatuses comprises a storage unit for storing the information on how to operate the processing apparatus, a second connecting unit connectable with the display unit, and a second controller for transmitting the information on how to operate the processing apparatus stored on the storage unit to the display apparatus via the second connecting unit based on information inputted via the second connecting unit and detected at the input detector.

Further objects, features and advantages of the present invention will become apparent from the following description of the preferred embodiments (with reference to the attached drawings).

### BRIEF DESCRIPTION OF THE DRAWINGS

FIG. 1 illustrates the exterior of a help display terminal 1.

FIG. 2 illustrates the help display terminal 1 before being connected to a copier 7.

FIG. 3 illustrates the help display terminal 1 connected to the copier 7.

FIG. 4 illustrates an initial screen of a help display terminal.

FIG. 5 illustrates an image of a manual displayed on the screen of a help display terminal.

FIG. 6 illustrates an image of a search result displayed on the screen of a help display terminal.

FIG. 7 illustrates an image of a history list displayed on the screen of a help display terminal.

FIG. 8 is a perspective view of an inkjet printer 26.

FIG. 9 illustrates the help display terminal 1 connected to the inkjet printer 26.

FIG. 10 illustrates the help display terminal 1 connected to a digital camera 30.

FIG. 11 illustrates an image of a resolution change screen displayed on the screen of a help display terminal 1.

FIG. 12 is a flowchart of the process for after the help display terminal 1 is connected to a product.

FIG. 13 is a block diagram illustrating the help display terminal 1 and a product.

FIG. 14 illustrates an image of a copy command screen displayed on the screen of a help display terminal 1.

FIG. 15 illustrates a help display terminal and a connecting unit.

### DESCRIPTION OF THE PREFERRED EMBODIMENTS

Embodiments of the present invention are described in detail below.

First Embodiment

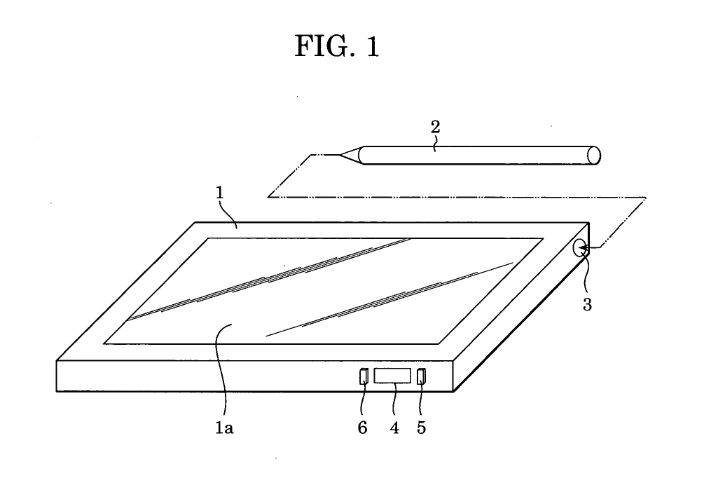

FIG. 1 illustrates a help display terminal 1.

According to this embodiment, a display unit 1a of the help display terminal is a liquid crystal panel. The surface of the display unit 1a includes a resistive touch screen (input unit). The display unit 1a may also be an EL panel or other types of display unit. Input is possible by touching the display unit 1a with a plastic pen-type stylus 2. A hole 3 formed on the help display terminal 1 is provided for storing the stylus 2. The input means used for the display unit 1a is not limited to a resistive touch screen, and any type of input means may be used as long as the coordinates indicated by a finger or an input device, such as the stylus 2, touching the display unit 1a can be detected. For example, known technologies utilizing electromagnetic induction, supersonic, or electric capacitance may also be used for the input means.

On the bottom surface of the help display terminal 1, a connector 4 similar to those used for connecting a computer and peripheral devices is provided. The help display terminal 1 can be connected to various products and can receive various types of information stored in the memory of these products via the connector 4. The connector 4 is an interface connectable to various products. The help display terminal 1 also has a protrusion 5 and a power switch 6 that are described below.

The above-mentioned various products include all types of electronic products such as a copier, a printer, a digital camera, a facsimile, a VCR (video cassette recorder), and a washing machine. The electronic product may be any type of product as long as it includes storage means.

The help display terminal 1 includes a power source. In this way, when an electronic product, such as a digital camera or a video camera, is powered by a battery and is connected with the help display terminal 1, power is supplied from the power source of the help display terminal 1 to the product to prevent the product's battery from being consumed.

The power source of the help display terminal 1 may be a primary battery, a secondary battery, or an AC adapter. In this embodiment, the power source is a primary battery or a secondary battery.

When the help display terminal 1 is connected to a product, the power switch 6 comes into contact with the product and is depressed. The power switch 6 is urged in a power-off direction by urging means not shown in the drawing. Therefore, when the help display terminal 1 is disconnected from the product, the power of the help display terminal 1 is automatically turned off.

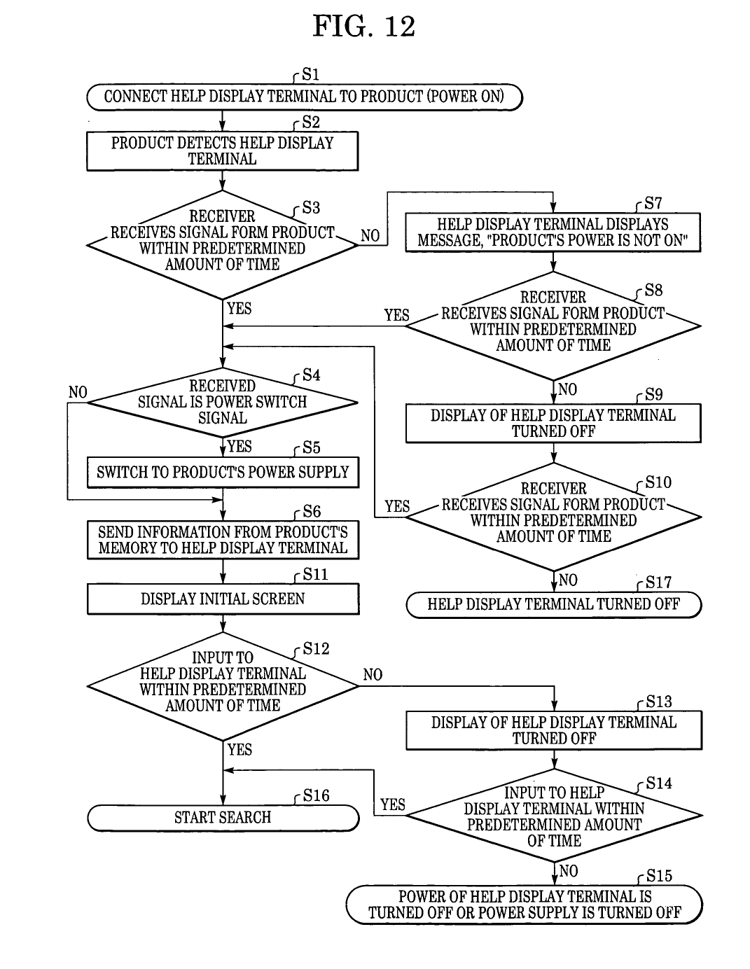

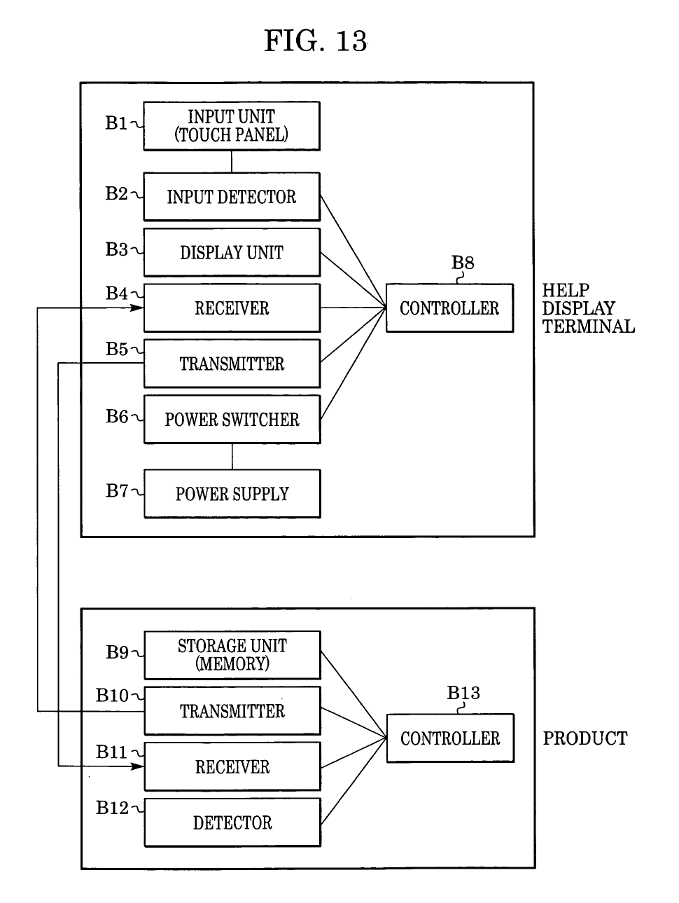

FIG. 12 is a flow chart illustrating a process including a series of steps from connecting a product to the help display terminal 1 to starting a search. FIG. 13 is a block diagram of the help display terminal 1 and a product. The block diagram only illustrates the components of the product that are connected to the help display terminal 1.

First, the steps of the process for when a product's power source is turned on are described below.

By connecting the help display terminal 1 to a product, the power switch 6 is pressed down and the help display terminal 1 becomes displayable by its power being turned on (Step S1 in FIG. 12). A micro-switch is provided on the product, and the protrusion 5 is provided on the help display terminal 1 at a position opposing the micro-switch. In this way, the micro-switch is depressed when the help display terminal 1 is connected to the product. When the protrusion 5 presses down the micro-switch, detecting means included in a controller B13 (refer to FIG. 13) of the product detects that the help display terminal 1 has been connected to the product. In other words, the micro-switch functions as a detector B12 (refer to FIG. 13) for detecting the help display terminal 1 connected to the product.

Instead of the above-described structure, an optic sensor may be provided on the product and a blocking unit may be provided on the help display terminal 1 at a position opposing the optical sensor of the product so that the optical sensor is blocked when the help display terminal 1 is connected to the product.

Preferably, the detector B12 for each product should have a common structure. The structure, however, may differ slightly as long as each detector is capable of transmitting and receiving signals. For example, a copier 7 might have an optical sensor and a digital camera 30 might have a micro-switch. When the help display terminal 1 is connected to the copier 7, the protrusion 5 blocks the optical sensor and the help display terminal 1 is detected. On the other hand, when the help display terminal 1 is connected to the digital camera 30, the protrusion 5 presses down the micro-switch and the help display terminal 1 is detected.

In this way, the help display terminal 1 can be used for all types of products. Moreover, if the detector of a product is structured so that it is connectable with the help display terminal 1, the help display terminal 1 can be used for various types of products made by different manufacturers.

One of the pins of the connector 4 may be used to detect the connection between the help display terminal 1 and a product. When the help display terminal 1 is connected with a product, a transmitter B5 (refer to FIG. 13) sends a signal to a receiver B11 (refer to FIG. 13) of the product, informing that the help display terminal 1 has been connected. Then, the detecting means included in the controller B13 detects that the help display terminal 1 has been connected.

Another detection method is to use a two-way communication interface (e.g., IEEE 1394). In this case, one of the pins of the interface functions as the detector B12.

In such a case, if the connectors and signals are common for the products made by different manufacturers, the help display terminal 1 can be connected to any of these products made by different manufacturers.

When the product detects that the help display terminal 1 has been connected (Step S2 in FIG. 12), the process proceeds to the subsequent steps in which it is determined whether to switch the power supply of the help display terminal 1.

The help display terminal 1 includes a power switcher B6 (refer to FIG. 13). The power switcher B6 allows the help display terminal 1 to switch between being powered by its own power supply and being powered by the power source of the product connected to the help display terminal 1. Once the help display terminal 1 is connected with a product, the help display terminal 1 receives power from its own power source until the power source (AC power supply or battery) of the product is determined and until whether it is detected that the product's power is turned on or off.

Whether the help display terminal 1 is going to be powered by its own battery or by a product's power source depends on the power source of each product. When the help display terminal 1 is connected to a product powered by an AC power source, the help display terminal 1 receives power from the product.

Some of the products that mainly operate on a battery can also receive power via an AC adapter. When the help display terminal 1 is connected to such a product, the help display terminal 1 receives power from the product only when the product is receiving power via an AC adapter.

When the help display terminal 1 is connected to a product that is receiving power from an AC power source or via an AC adapter, a transmitter B10 (refer to FIG. 13) of the product sends a power switch signal to a receiver B4 (refer to FIG. 13) of the help display terminal 1 (Steps S3 and S4 in FIG. 12). When the receiver B4 of the help display terminal 1 receives the signal, a controller B8 controls the power switcher B6 so that the help display terminal 1 receives power from the product (Step S5 in FIG. 12). Then, various types of information stored on a memory B9 (refer to FIG. 13) of the product are sent to the receiver B4 via the transmitter B10. Then, the controller B13 of the product controls the help display terminal 1 to display an initial screen (Steps S6 to S11 in FIG. 12).

When the help display terminal 1 is connected to a product powered by a battery, instead of a power switch signal, various types of information stored in the memory B9 of the product are sent from the transmitter B10 of the product to the receiver B4 of the help display terminal 1 via the controller B13 of the product. Accordingly, the help display terminal 1 continues to be powered by its own power source. According to the information received by the receiver B4, the controller B8 controls the help display terminal 1 so that an initial screen is displayed (Steps S4 to S6 to S11 in FIG. 12).

The memory for a product is not limited to a particular type of memory. Each product may have a different type of memory. The memory may be a built-in memory or may be a replaceable memory, such as a digital versatile disc (DVD), a compact disc-read only memory (CD-ROM), or a memory stick. The most preferable type of memory may be selected according to update frequency of the instruction manual and the various types of information, the size of the product, and the amount of the data to be stored in the memory.

As described above, when the help display terminal 1 is connected to a product powered by a battery, the battery of the product is prevented from being consumed.

When the help display terminal 1 according to this embodiment that is powered by its own battery is connected to a product powered by an AC power source, the battery of the help display terminal 1 is not consumed so that the battery power of the help display terminal 1 can be used efficiently when, in the future, the help display terminal 1 is connected to a product powered by a battery.

Without carrying out any special operations, a user can connect the help display terminal 1 to a product to display various type of information stored on a memory of a product on the screen of the help display terminal 1.

By leaving the help display terminal 1 connected to a product, the help display terminal 1 can be used as an instruction manual of the product. Furthermore, by leaving the help display terminal 1 connected to a product, the help display terminal 1 can also be used as a controller for the product.

The display of the help display terminal 1 is controlled in a manner that allows the help display terminal 1 to be continuously connected to a product. After the help display terminal 1 is connected to a product, if a predetermined amount of time elapses without an input provided by a user (i.e., without the user touching the screen) after the initial screen is displayed (Step S11 in FIG. 12), the display of the help display terminal 1 is turned off (Steps S12 to S13 in FIG. 12). If an input is still not provided by the user for a predetermined amount of time after the display is turned off, the power of the help display terminal 1 is turned off (Steps S14 to S15 in FIG. 12). In such a case, if the help display terminal 1 was receiving power from the product, the help display terminal 1 stops receiving power from the product.

Accordingly, even if the help display terminal 1 is not used while it is left connected with a product, the help display terminal 1 does not consume power. To use the help display terminal 1 after it is automatically turned off, the help display terminal 1 must be disconnected and then reconnected with the product.

When a user provides an input to the help display terminal 1 (Step S12 in FIG. 12) after the initial screen is displayed (Step S11 in FIG. 12) and before a predetermined amount of time elapses, a search begins based on the input (Step S16 in FIG. 12).

After a search begins (Step S16), if a user does not provide an input to the help display terminal 1 (i.e., the user does not touch the screen) for a predetermined amount of time while the search results are displayed on the help display terminal 1, the help display terminal 1 is turned off. If a user does not provide an input (i.e., the user does not touch the screen) for a predetermined amount of time after the display is turned off, the power of the help display terminal 1 is turned off. At this time, the power supply from the product to the help display terminal 1 is terminated if the help display terminal 1 had been receiving power from the product. The steps after S16 in FIG. 12 are the same as Steps S12 through S15 in FIG. 12. Therefore, further descriptions for these steps are omitted.

Next, a process for when a product's power is turned off is described.

When the help display terminal 1 is connected to a product, the power switch 6 is depressed (Step S1 in FIG. 12) and the help display terminal 1 is detected (Step S2 in FIG. 12) by the detector B12 and the controller B13 of the product. If the help display terminal 1 does not receive a power switch signal or various types of information from a product, powered either by an AC power source or a battery, within a predetermined amount of time, the help display terminal 1 determines that the product's power is turned off and displays the message, “product power off” (Steps S3 to S7). If the product's power remains off and the help display terminal 1 does not receive any signal after a predetermined amount of time after the message is displayed, the display is turned off (Steps S8 and S9).

If the product's power is turned on within a predetermined amount of time after the message is displayed, the help display terminal 1 selects its power source in accordance with the information sent from the product (Steps S8 to S4).

If the product's power is turned on within a predetermined amount of time after the display is turned off, the display is turned on again and the help display terminal 1 selects its power source in accordance with the information sent from the product (Steps S9 to S10 to S4).

If the product's power is not turned on and the help display terminal 1 does not receive any signals within a predetermined amount of time after the display is turned off, the power of the help display terminal 1 is turned off (Steps S10 to S17).

A case in which the help display terminal 1 is connected to a copier will be described below.

Once the copier detects the help display terminal 1, the copier sends a power switch signal to the help display terminal 1 since the copier is powered by an AC power source. When the help display terminal 1 receives the signal (Step S4), it switches its power source to the AC power source of the copier (Step S5). Then, various types of information stored on the memory of the copier are sent to the help display terminal 1 (Step S6) and an initial screen is displayed on the help display terminal 1 (Step S11).

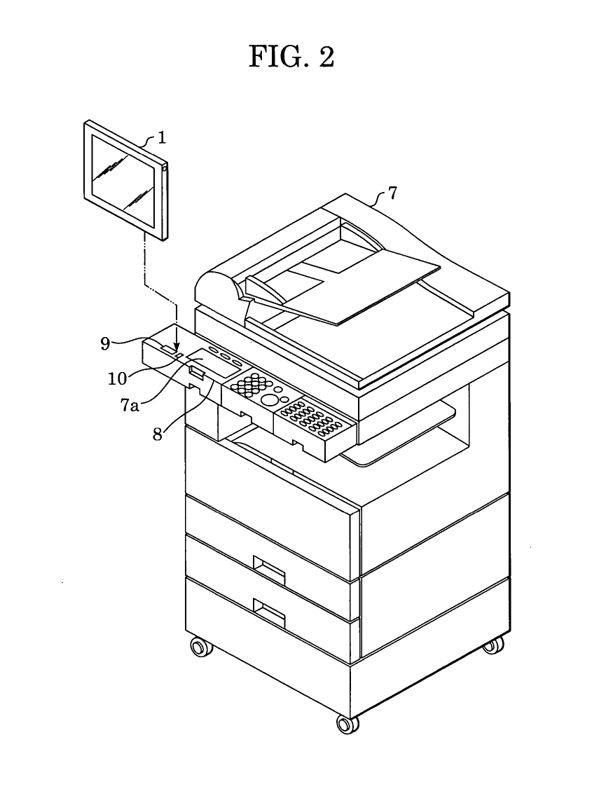

FIG. 2 illustrates a copier 7. On the left of an operation panel 8 of the copier 7, a signal transmitter, a connector 9 functioning as a power supplier of the help display terminal 1, and an optical sensor 10 functioning as a detector B12 (refer to FIG. 13) are provided.

If one of the pins of the above-mentioned connector is used to detect the help display terminal 1, the optical sensor 10 can be omitted.

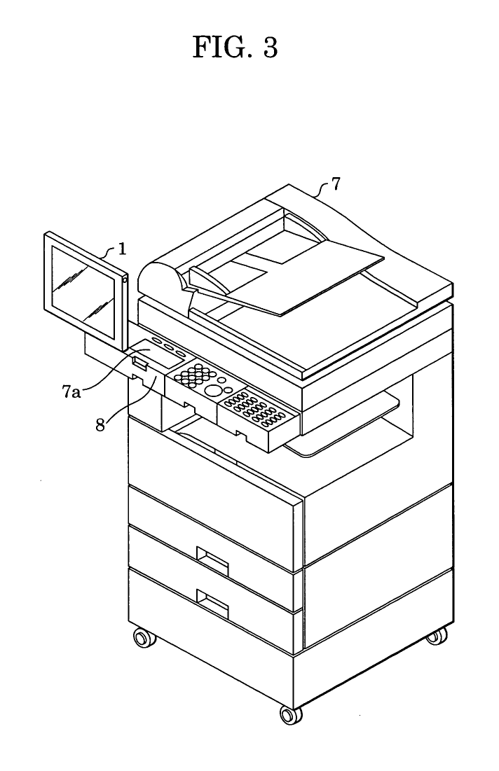

FIG. 3 illustrates the help display terminal 1 connected to the copier 7. The help display terminal 1 is positioned so that it does not interfere with the operation panel 8 of the copier 7 and with the operation of feeding a document into the copier 7.

The help display terminal 1 is fixed to the copier 7 by supporting means (not shown in the drawing) provided on the back side of the help display terminal 1 or on the copier 7 so that no load is applied to the connector. In this way, a user does not have to hold the help display terminal 1 while operating the help display terminal 1.

The help display terminal 1 display information related to an instruction manual, an operation guide, and help information.

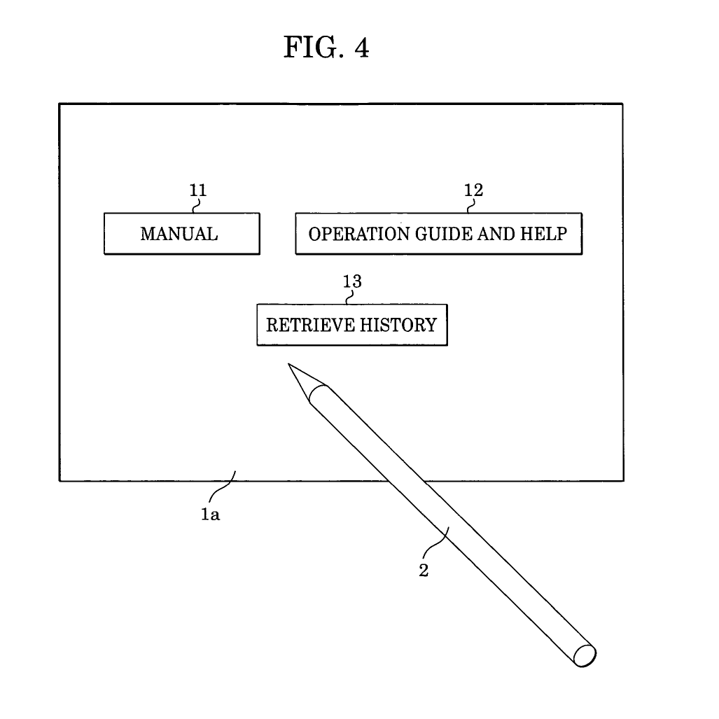

As illustrated in FIG. 4, first, three icons (a MANUAL icon 11, an OPERATION GUIDE AND HELP icon 12, and a RETRIEVE HISTORY icon 13 are displayed. The RETRIEVE HISTORY icon 13 will be described further below.

To view information related to the instruction manual, a user touches the MANUAL icon 11 with a finger or a stylus.

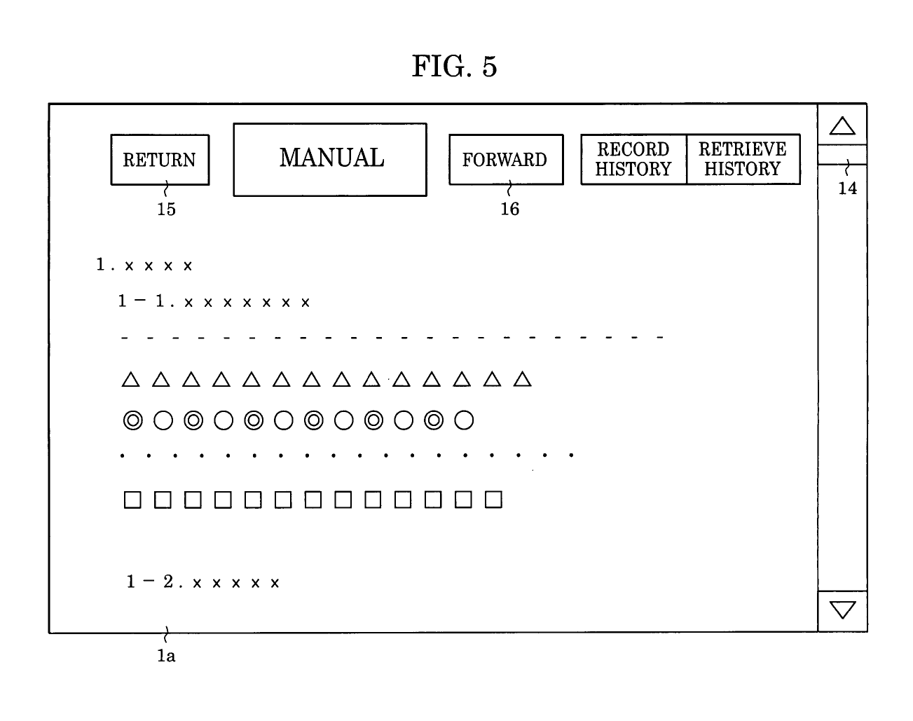

When an input detector B2 (refer to FIG. 13) detects that a user has touched an input unit B1 (refer to FIG. 13), i.e., an icon displayed on the screen, a signal for requesting subsequent information is sent to the product via the controller B8 and the transmitter B5. Then, the subsequent information is sent from a memory B9 of the copier 7 to the help display terminal 1 via a controller B13 and a transmitter B10, and the screen displays information related to the instruction manual, as illustrated in FIG. 5. The content of the displayed information may be digitized data, such as a PDF, of the paper instruction manual or may be other types of data.

A user can scroll through the instruction manual displayed on the screen to search for the desired information. To scroll through the information, a user may use the stylus or finger to drag a scroll bar 14 on the right edge of the screen or may use the stylus or finger to touch a RETURN icon 15 or a FORWARD icon 16. Furthermore, the operation panel 8 of the copier 7 may be operated to scroll through the information displayed on the screen of the help display terminal 1. For example, if the digitized data of the instruction manual includes page numbers, a predetermined page can be selected by inputting the page number with the numerical keypad on the operation panel 8 of the copier 7 (for example, to jump to page 50, the user inputs the numbers ‘5’ and ‘0’ using the numerical keypad).

The screen of the help display terminal 1 is larger than a liquid crystal display 7a of the copier 7. Therefore, the screen of the help display terminal 1 is easily viewable and can display a large amount of information. For this reason, the digitized instruction manual displayed on the help display terminal 1 can be used in the same manner as a known paper instruction manual.

When a user wants to find out how to carry out a particular operation or to find information on a particular function, or wants instructions for a particular operation, the user can touch the OPERATION GUIDE AND HELP icon 12 on the screen, as illustrated in FIG. 4. To find the desired information, the user can touch the relevant icon to proceed to information stored in a lower hierarchy or can input a keyword using the stylus. The information stored in the memory of the copier 7 can be retrieved through a keyword search.

When a user finds the desired information on a particular function by using the MANUAL icon 11 or the OPERATION GUIDE AND HELP icon 12, illustrated in FIG. 4 an operation icon is displayed. By touching the operation icon, a signal is sent to the controller B13 of the copier 7 via the input detector B2, the controller B8, the transmitter B5, and the receiver B11. In this way, the copier 7 can be operated by touching the operation icon.

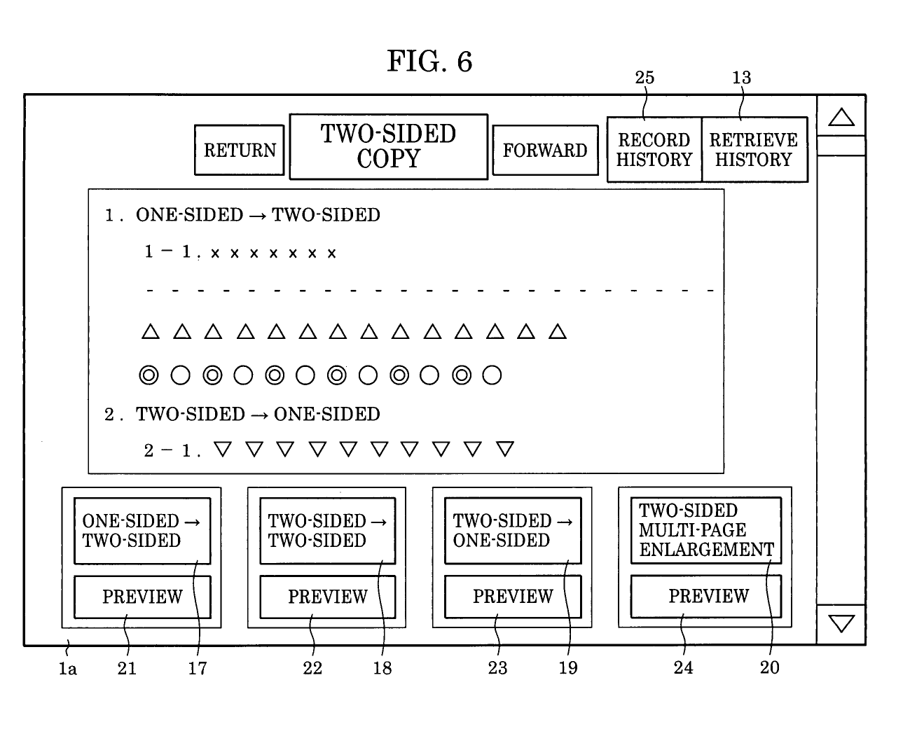

For example, the result of a search based on the keyword, ‘two-sided copy,’ is illustrated in FIG. 6.

Along with the information on the function and the instructions for the operation, four icons (a ONE-SIDED→TWO-SIDED icon 17, a TWO-SIDED→TWO-SIDED icon 18, a TWO-SIDED→ONE-SIDED icon 19, and a TWO-SIDED MULTI-PAGE ENLARGEMENT icon 20) are displayed. The displayed icons 17 to 20 function as operation keys. Therefore, when a user touches an icon, a signal is sent to the controller B13 of the copier 7 so that the operation is carried out. When an operation requires a user to perform a plurality of key operations and when it is detected that the user has touched an operation icon displayed on a guide screen, the screen is changed to a guide screen for the subsequent operation and another operation icon for the subsequent operation is displayed.

Images related to various functions are stored in the memory B9 of the copier 7. How to use these images is described below.

As illustrated in FIG. 6, descriptions of a function are displayed on the upper portion of the screen, and PREVIEW icons 21 to 24 are displayed on the lower portion of the screen.

By touching the PREVIEW icons 21 to 24, relevant information is displayed as a series of images. A user may use this function when the user wants to make sure the search result is what the user was searching for, when the user cannot understand the operation by reading the description displayed on the screen, when the operation is complicated, or when the user is not familiar with operating electronic apparatuses.

By confirming the search results by using the PREVIEW function before actually performing the operation, operation mistakes due to misunderstanding or assumptions can be prevented and the procedures for the operation can be fully grasped in advance.

The image displayed by using the PREVIEW function may be a series of still images or a moving image. The color of the image(s), the number of still images, the length of the moving image, and the resolution of the image(s) may be determined according to the memory capacity of the product as long as the image(s) can be displayed on the help display terminal 1 and can be synchronized with the operation carried out by a user. By using a memory having a large capacity, a large amount of image data can be stored and detailed help information can be provided. In this way, the information provided by the help display terminal 1 will be more detailed than a paper instruction manual.

As long as the image data is displayable on the help display terminal 1, the format for the image data provided by each product does not have to be the same since the data is not exchanged between products. Not only the image data but also the format for the instruction manual does not have to be the same for each product as long as the instruction manual can be searched by the help display terminal 1 and the product can be controlled by icons displayed on the help display terminal 1.

Moving images are stored on the memory of the copier 7 according to this embodiment.

As described above, as a result of a search on ‘two-sided copy,’ the PREVIEW icons 21 to 24 are displayed, as illustrated in FIG. 6. By touching the PREVIEW icon 21 disposed below the ONE-SIDED→TWO-SIDED icon 17, a moving image describing the operation for making a double-sided copy of a single-sided document is sent from the memory of the copier 7 to the screen of the help display terminal 1. Similarly, by touching the other three PREVIEW icons 22 to 24, moving images corresponding to the operation icons 18 to 20 disposed above the PREVIEW icons 22 to 24 are displayed. A moving image includes images of a user operating the copier 7. The moving image is repeatedly displayed to show details of operations, such as which direction to position an original document, how to set the paper, how to select a cassette, and how to obtain an output.

Since the operation icons 17 to 20 are displayed on the preview screen, the copier 7 can be operated by these icons even when preview images are displayed. For example, when the copier 7 detects that a user has touched the ONE-SIDED→TWO-SIDED icon 17 after setting a document, controlling means for controlling the help display terminal 1 changes the content of the preview screen in accordance with the operation carried out by the user. When the copier 7 detects that a user has set a document, the preview images for the steps before setting a document are omitted and preview images for the subsequent steps are repeatedly displayed. The operation carried out by a user and the content of the preview images are synchronized. In other words, the preview image does not change until the user carries out the correct operation. In this way, the user is prevented from making an operation mistake.

Since the preview image provides details of an operation, a user can confirm the operation before actually carrying it out. Moreover, intricate operations that only experienced users have been able to understand and carry out can be explained in detail to inexperienced users. In this way, mistakes, such as feeding a document in a wrong direction and producing miscopies, can be prevented.

Operations that include steps that are too complicated to memorize and operations that are difficult and require the assistance of the help display terminal 1 can be stored in a writable region of the memory of the product as entries in a history list. For example, when a user finds the desired information by performing a search, the user can touch a RECORD HISTORY icon 25, as shown in FIG. 6, to write the information and date of this search in the writable region of the memory.

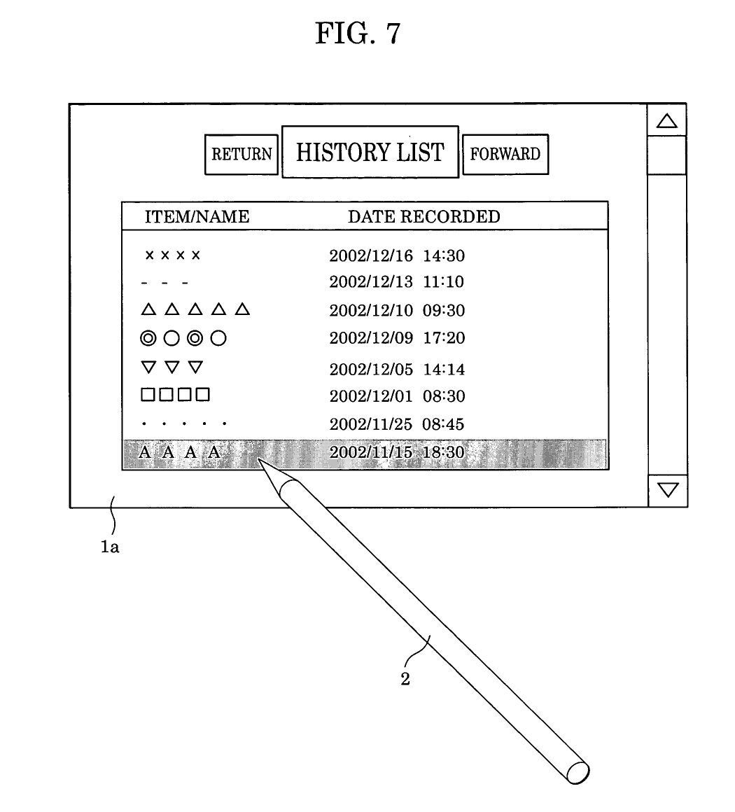

The RETRIEVE HISTORY icon 13 is always displayed on the screen of the help display terminal 1, as shown in the screens depicted in FIGS. 4 through 6. When a user wants to check the stored history, the user touches the RETRIEVE HISTORY icon 13 to display a history list, as illustrated in FIG. 7. The user selects an item in the list with the stylus or finger to change the information displayed on the screen.

FIG. 7 illustrates a state in which a section of the screen relating to a function AAAA is touched by a stylus. Immediately after touching the section, the screen displays information related to the function AAAA.

A case in which the help display terminal 1 is connected to another product will be described below.

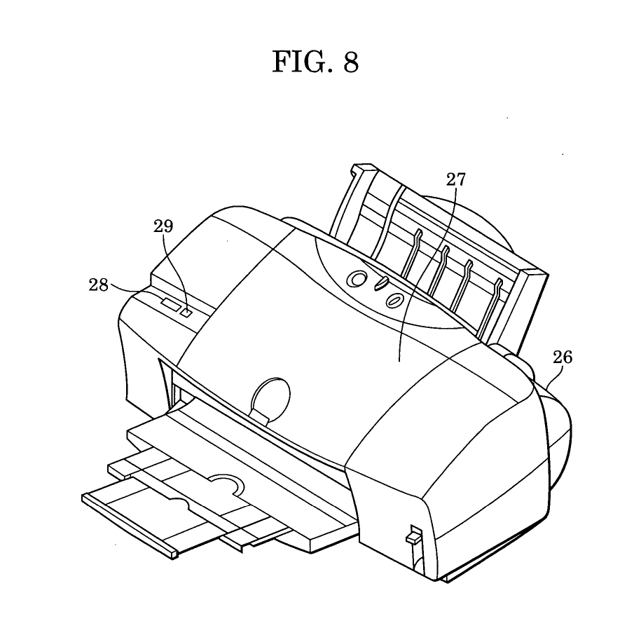

FIG. 8 illustrates an inkjet printer 26. Similar to the copier 7, a connector 28 functioning as a signal transmitter and receiver and an optical sensor 29 functioning as a detector are provided on the left side of a central cover 27 on the inkjet printer 26.

If one of the pins of the above-mentioned connector is used for detecting the help display terminal 1, the optical sensor 29 can be omitted.

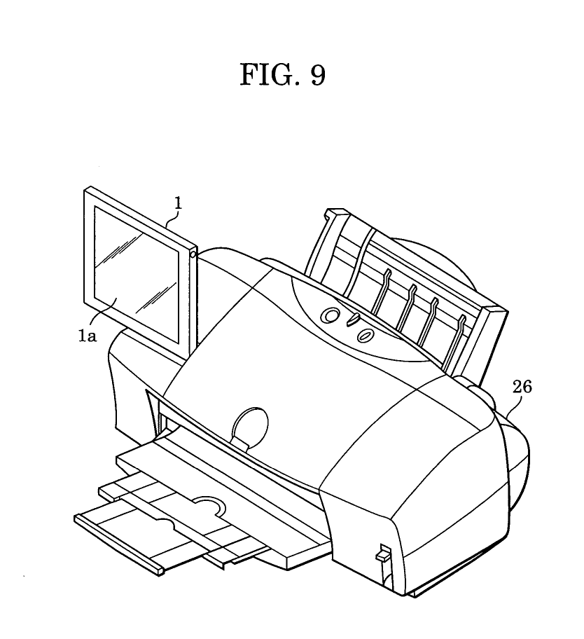

FIG. 9 illustrates the help display terminal 1 connected to the inkjet printer 26. Since the help display terminal 1 is connected to the inkjet printer 26 at a position shown in FIG. 9, the help display terminal 1 does not interfere with paper-setting, key operations, and opening and closing of the cover 27.

The help display terminal 1 is fixed to the ink-jet printer 26 by supporting means (not shown in the drawing) provided on the back side of the help display terminal 1 or the inkjet printer 26 so that no load is applied to the connector. In this way, a user does not have to hold the help display terminal 1.

The steps for connecting the help display terminal 1 to the inkjet printer 26, sending various types of information stored in the memory of the inkjet printer 26 to the help display terminal 1, and displaying images on the display unit 1a of the help display terminal 1 are the same as the steps for the copier 7.

The initial screen for the help display terminal 1 connected to the inkjet printer 26 is the same as that illustrated in FIG. 4.

How to search information by using each icon and how to display a preview image are the same as for the copier 7. Therefore, detailed descriptions are omitted.

For example, the steps for performing a search on a recovery process for cleaning the ink outlets of the inkjet printer 26 and the steps for carrying out the recovery process are now described. By touching the MANUAL icon 11 or the OPERATION GUIDE AND HELP icon 12 and performing a search on how to clean the ink outlets, a description of the recovery process and various icons are displayed on the screen of the help display terminal 1. When a user wants to remove the ink from the outlet, the user can choose the RECOVERY BY SUCTION icon to suck out the ink in the outlet and its vicinity with a pump included in the inkjet printer 26.

Often, the inkjet printer 26 does not include a liquid crystal panel and is controlled by a computer connected to the inkjet printer 26. The inkjet printer 26, however, can also be controlled by the help display terminal 1 according to the present invention. Thus, even when the computer is turned off, a user can perform a search concerning the inkjet printer 26, such as a search on how to perform a particular operation, by connecting the help display terminal 1 with the inkjet printer 26.

When the inkjet printer 26 is positioned far away from the computer, for example, to replace an ink cartridge, a user had to look up how to replace the ink cartridge on the computer and then move to where the inkjet printer 26 is positioned. By connecting the help display terminal 1 to the inkjet printer 26, a search can be performed on the process for replacing the ink cartridge using the help display terminal 1. In this way, the user can replace the ink cartridge while looking at the information displayed on the help display terminal 1. As a result, the user does not have to go back and forth between the inkjet printer 26 and the computer.

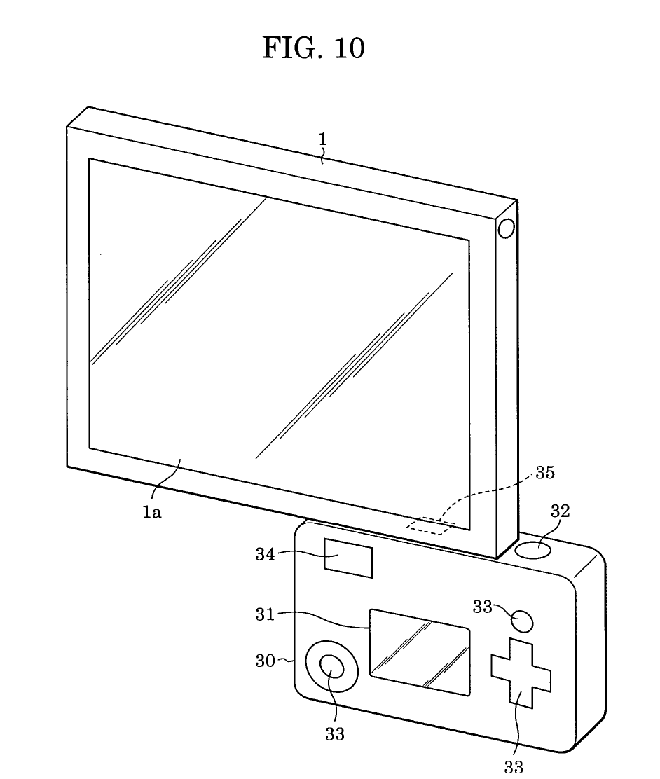

FIG. 10 illustrates the help display terminal 1 connected to a digital camera 30. The digital camera 30 is provided with a liquid crystal panel 31 for checking the subject when taking a photograph or for checking the image after taking the photograph. The digital camera 30 also includes a shutter release button 32, various operation keys 33, and a viewfinder 34. A connector (not depicted in the drawing) functioning as a signal receiver and transmitter is provided at a section 35, indicated by a dotted line in FIG. 10, for detecting whether the help display terminal 1 is connected with the digital camera 30 when the protrusion 5 (refer to FIG. 1) of the help display terminal 1 presses down a micro-switch (not depicted in the drawing) on the digital camera 30.

As illustrated in FIG. 10, the help display terminal 1 is connected at a position that does not interfere with the shutter release button 32 on the digital camera 30. The display unit 1a of the help display terminal 1 is facing the same direction as the liquid crystal display 31 of the digital camera 30. Accordingly, a user can take photographs or reproduce the photographed images on the digital camera 30 while operating the help display terminal 1.

When the help display terminal 1 is connected with the digital camera 30 and the digital camera 30 is powered by a battery, a power switch signal is not sent to the help display terminal 1 but various types of information stored in the memory of the digital camera 30 are sent to the help display terminal 1. In this way, the help display terminal 1 continues to be powered by its own battery.

When the digital camera 30 is powered via an AC adapter, a power switch signal is sent to the help display terminal 1. When the help display terminal 1 receives this signal, the power switching means of the help display terminal 1 switches the power of the help display terminal 1 to the AC power source of the digital camera 30 via the controller of the help display terminal 1. Then, the help display terminal 1 turns on its display with the power from the digital camera 30.

Because the help display terminal 1 is capable of switching its power, the help display terminal 1 can be used for products ranging from relatively large products powered by an AC power source to small products powered by a battery.

The steps for connecting the help display terminal 1 to the digital camera 30, sending various types of information stored in the memory of the digital camera 30 to the help display terminal 1, and displaying the display unit 1a on the help display terminal 1 are the same as the steps for the copier 7 and the inkjet printer 26 (except that the power of the help display terminal 1 is not switched when powered by a power source).

The initial screen for the help display terminal 1 connected to the digital camera 30 is the same as that illustrated in FIG. 4.

How to search information by using each icon and how to display a preview are the same as the inkjet printer 26. Therefore, detailed descriptions are omitted.

For example, the steps for performing a search on changing the resolution when taking photographs will be described below.

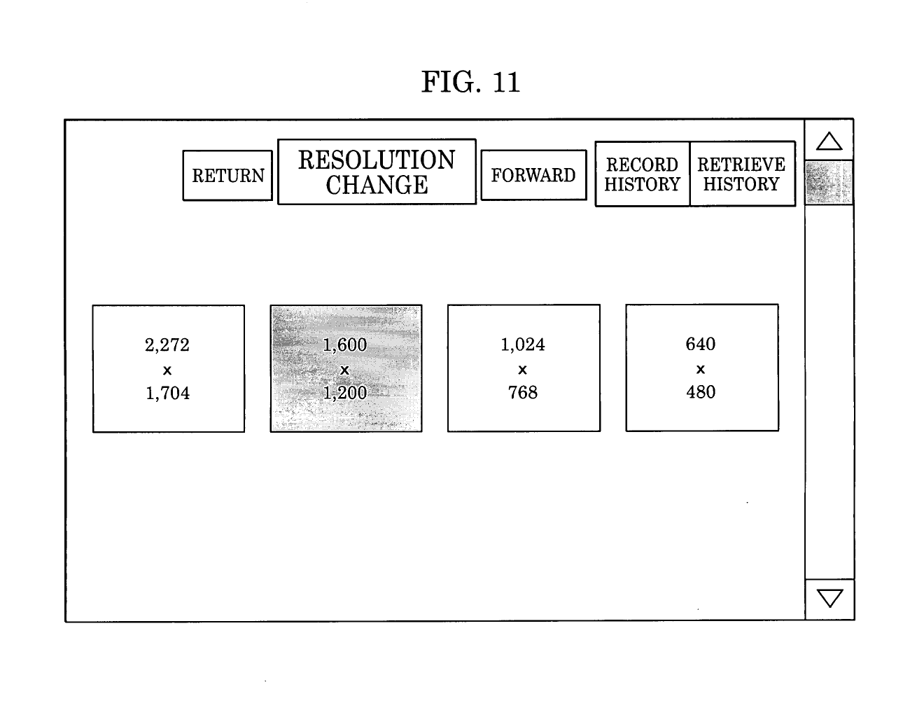

By touching the MANUAL icon 11 or the OPERATION GUIDE AND HELP icon 12 to search the steps for changing the resolution, a RESOLUTION CHANGE icon is displayed along with descriptions of the steps. When a user touches the icon, four icons (a 2,272×1,704 icon, a 1,600×1,200 icon, a 1,024×768 icon, and a 640×480 icon) are displayed, as illustrated in FIG. 11.

The 1,600×1,200 icon is displayed in a darker color to show that the resolution is currently set at 1,600×1,200. To select another resolution setting, a user touches one of the other three icons. As a result, a signal is sent to the controller of the digital camera 30.

Often, the digital camera 30 includes a liquid crystal display 31. Function settings can be selected on the liquid crystal display 31. However, the display area is usually small, and, accordingly, the displayed text is small, being difficult to read for someone having farsightedness, such as an elderly person. The help display terminal 1 has a sufficiently large display screen, and, thus, operation mistakes can be prevented by providing legible detailed descriptions.

The controller B13 of the product or the controller B8 of the help display terminal 1 may include analyzing means for analyzing the meaning of not only a word but entire text to enable a search to be performed on the text inputted by pen into the help display terminal 1. For a keyword search performed by a computer, when there is no matching word, the closest results are displayed. However, in such a case, not always the desired results are obtained, or, in the worst, no results are obtained at all. Moreover, when there are no fully matching results, a plurality of other closer results is displayed. In such a case, a user has to select one of the results and proceed to look through the information stored in a lower hierarchy to find the desired results.

The help display terminal 1 according to the present invention includes the analyzing means for analyzing the meaning of text. Therefore, even when a user does not know the correct terminology when performing a search, the user can input a question or a request. In this way, the help display terminal 1 analyzes the meaning of the question or the request and provides information corresponding to the question or the request.

The phrase (question or request) input at the touch panel B1 is sent to the controller B8 via the input detector B2. The phrase may be sent to the receiver B11 of the product via the transmitter B5 after the meaning of the phrase is analyzed at the controller B8, or the text data may be sent from the controller B8 to the controller B13 of the product, where the meaning of the phrase is analyzed. Information corresponding to the analyzed phrase is retrieved from the memory B9, and this information is sent to the display screen of the help display terminal 1 via the transmitter B10, the receiver B4, and the controller B8.

In this way, a plurality of search results are not displayed and a user can obtain the most desired results in a short amount of time. Then, the user can quickly carry out the operation. When performing a search on a function that is usually not used, the information concerning this function is stored in a very low hierarchy, being difficult to retrieve. In the above-mentioned search process, even such information can be easily retrieved. Thus, the various functions of the product can be fully utilized.

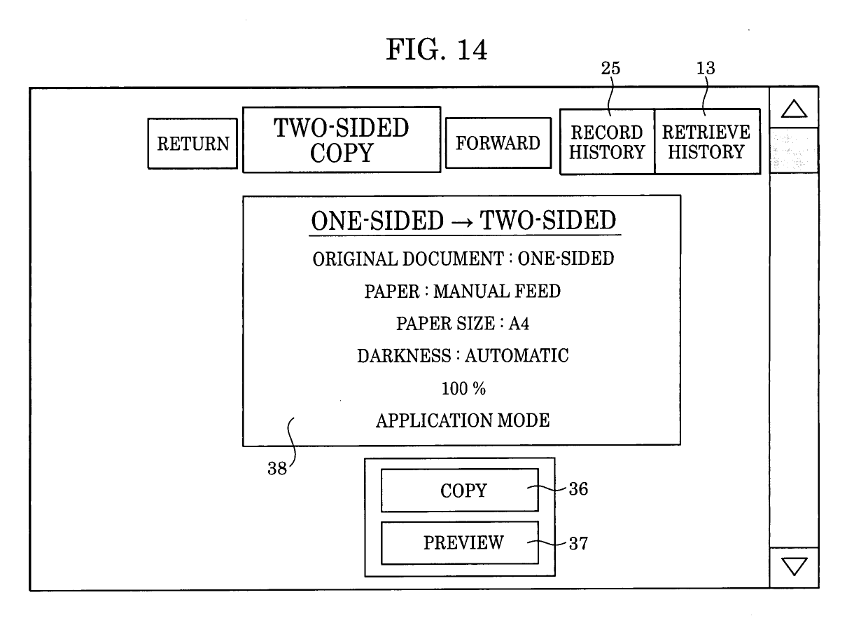

For example, if the phrase, “copying a one-sided document onto both sides of hand-fed piece of paper,” is input, information is displayed on the screen, as illustrated in FIG. 14. By touching a COPY icon 36, copying begins as the conditions listed in icon 38 are met. By touching the PREVIEW icon 37, as described above, a moving image related to the operation is displayed. To change the conditions listed in the icon 38, a user touches the icon 38 to proceed to a subsequent screen when the user can make changes.

To reach the screen illustrated in FIG. 14 from the OPERATION GUIDE AND HELP icon 12, illustrated in FIG. 4, the user must proceed through several screens. The screen illustrated in FIG. 14 can be displayed by directly inputting a phrase. When a user knows what information is desired, the correct information can be retrieved in a short amount of time by inputting a phrase.

In the above, cases in which the help display terminal 1 is connected to a copier, an inkjet printer, and a digital camera have been described. The help display terminal 1 can be connected to other products, such as a facsimile, a laser beam printer, audio equipment, or a household appliance, as long as the product has the structure illustrated in FIG. 13.

Second Embodiment

The help display terminal 1 according to the first embodiment selects either its own battery power or a power source of the product based on the type of the product's power source. Instead of this, the help display terminal 1 can select either its own battery power or the product's power source based on the remaining power of its own battery.

When the help display terminal 1 is connected to a product powered by a battery, a signal is sent from the transmitter B10 (in FIG. 13) of the product to the receiver B4 of the help display terminal 1. This signal is a power switch signal for allowing the help display terminal 1 to be powered by the product's battery when the product's battery has a sufficient amount of remaining power. When the remaining battery power of the product is not sufficient, a signal including various types of information stored in the memory of the product is sent to the help display terminal 1 so that the help display terminal 1 is not powered by the product's battery.

Even after the help display terminal 1 is connected to the product having a sufficient amount of remaining battery power and is powered by the product's battery, if the battery power of the product becomes low, a power switch signal is sent again from the product so that the help display terminal 1 switches back to be powered by its own battery.

When an AC adapter is connected to a product powered by a battery, despite the remaining amount of battery power, the product sends a power switch signal to the help display terminal 1 so the help display terminal 1 is powered by the product's power source.

Third Embodiment

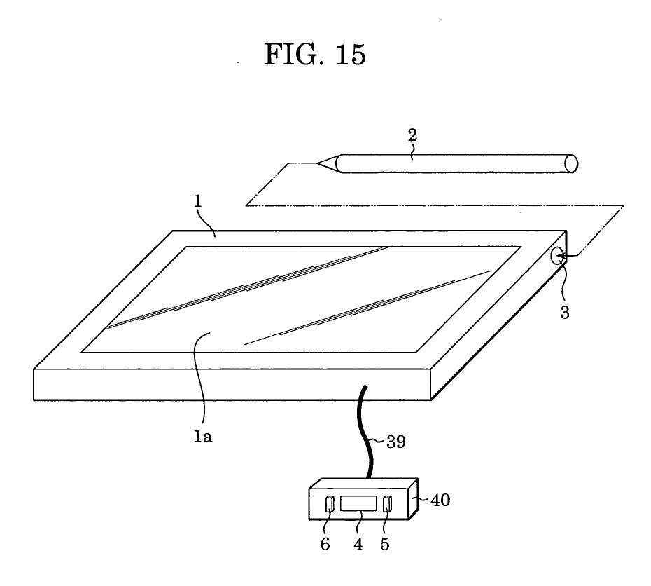

In the above-described embodiments, the help display terminal 1 and each product is directly connected with a connector having male and female pins. Instead of the connector, a cable may be used. Another embodiment of a help display terminal 1 is illustrated in FIG. 15. At the tip of a cable 39, a connecting unit 40 including a connector 4, a protrusion 5, and a power switch 6 is provided.

Signals may be transmitted and received via non-wire communication such as optical or radio communication.

For example, the help display terminal 1 and a product both may include a light-emitting unit and a light receiving unit to enable two-directional communication using infrared rays.

The above-described first, second, and third embodiments have the following advantages.

Since various types of information are stored in a memory of a product, paper instruction manuals are no longer necessary, searching for information in an instruction manual becomes easier, and storing and managing the instruction manuals become easier.

Since the display screen of the help display terminal is large, the content displayed is easily legible even for a user having farsightedness, such as an elderly person.

Since various types of information are displayed on the help display terminal, the display of a product is not occupied and the original content displayed on the screen of the product can be continued to be displayed.

Since information is displayed by simply connecting the help display terminal to a product and a user does not have to go through complicated steps for displaying the information, the help display terminal can be easily operated by a user, such as an elderly person, who is not used to operating electronic apparatuses.

Since the help display terminal is directly connected with a product, a user can operate the product while reading the instruction manual displayed on the help display terminal.

Since the result of a search performed by a user can be displayed as image data in addition to text data, the user can confirm the obtained information without actually operating a product.

Since the help display terminal is synchronized with the operations carried out by a user and the state of a product, the user will not make operation mistakes in response to the search results provided by the help display terminal.

Since the help display terminal analyzes the meaning of a phrase input by a user, the user can carry out an accurate search in a short amount of time even when the user does not know the correct terminology for a product.

When the help display terminal is powered by a battery, depending on the type of power source the product connected to the help display terminal uses, the help display terminal selects which power source to use (either its own battery or the product's power source). Thus, the help display terminal can be used efficiently while conserving its own battery power.

When the help display terminal is connected to a product powered by a primary or a secondary battery, the help display terminal selects which power source to use (either its own battery or the product's battery) depending on the remaining amount of the product's battery power. Thus, the product's battery power is not used up by the help display terminal and the batteries of both the help display terminal and the product can be used efficiently.

A unit that is capable of realizing the functions of the above-described embodiments by operating various devices in accordance with a software program code, which is executed to realize the functions of the above-described embodiments and which is supplied from a storage medium or via a transmitting medium, such as the Internet, to a computer (CPU or MPU) included in an apparatus or system connected to the various devices, is also included in the scope of the present invention.

In such a case, the software program code itself realizes the functions of the above-mentioned embodiments, and, thus, the program code itself or means for supplying the program code to a computer, (for example, a storage medium storing the program code), is an embodiment according to the present invention. The storage medium storing the program code may be, for example, a flexible disk, a hard disk, an optical disk, a CD-ROM, a magnetic take, an involatile memory card, or a ROM.

By executing the program code supplied to the computer, the operating system (OS) of the computer or other application software used cooperatively with the program code is also included in the scope of the present invention.

Processing of the program code carried out entirely or partially by a CPU included in a function expansion board of the computer or a function expansion unit connected to the computer after the program code is stored in a memory included in the function expansion board or the function expansion is also included in the scope of the present invention.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A display apparatus attachable to and removable from a plurality of processing apparatuses used for various purposes, comprising:
a display unit for displaying information;
an input unit for inputting information;
an input detector for detecting an input at the input unit;
a connecting unit connectable with the plurality of processing apparatuses disposed on the exterior of the display apparatus; and
a controller for displaying information on how to operate one of the processing apparatuses on the display unit connected via the connecting unit and for transmitting the information detected by the input detector connected to one of the processing apparatuses via the connecting unit.

2. The display apparatus according to claim 1, wherein the plurality of processing apparatuses include an imaging device for capturing an object and an output device for printing a predetermined image on a sheet.

3. The display apparatus according to claim 1, further comprising:
a power switching unit for switching between a power source of the display apparatus and a power source of one of the processing apparatuses.

4. An information system comprising:
a display apparatus attachable to and removable from a plurality of processing apparatuses used for various purposes, comprising:
a display unit for displaying information;
an input unit for inputting information;
an input detector for detecting an input at the input unit;
a first connecting unit connectable with the plurality of processing apparatuses disposed on the exterior of the display apparatus; and
a first controller for displaying information on how to operate one of the processing apparatuses connected via the connecting unit and for transmitting the information detected by the input detector connected to one of the processing apparatuses via the connecting unit;
wherein said one of the processing apparatuses comprises a storage unit for storing the information on how to operate said one of the processing apparatuses; a second connecting unit connectable with the display unit; and a second controller for transmitting the information on how to operate said one of the processing apparatuses stored on the storage unit to the display apparatus via the second connecting unit based on information inputted via the second connecting unit and detected at the input detector.

5. The information system according to claim 4, wherein the second controller controls the display unit to display steps of an operation one the display unit before a user operates said one of the processing apparatuses.

6. The information system according to claim 4, wherein the second controller controls the display unit to operate on power supplied by a power source of the display apparatus when the power supplied by the power source of said one of the processing apparatuses becomes less than a predetermined level.
